(19) United States
(12) Patent Application Publication
(10) Pub. No.: US 2024/0055215 A1
(43) Pub. Date: Feb. 15, 2024

(54) DESIGN FOR FIELD EMITTER X-RAY SOURCE RELIABILITY

(71) Applicant: X-SIGHT INCORPORATED, Cambridge, MA (US)

(72) Inventor: Winston Chern, Cambridge, MA (US)

(21) Appl. No.: 18/232,418

(22) Filed: Aug. 10, 2023

Related U.S. Application Data
(60) Provisional application No. 63/396,689, filed on Aug. 10, 2022.

(51) Int. Cl. H01J 35/14; H01J 35/06; H01J 35/16

(52) U.S. Cl. CPC H01J 35/153; H01J 35/065; H01J 35/16; H01J 35/147

(57) ABSTRACT

An X-ray source design for improved reliability by mitigating the impact of vacuum arcs, ion back bombardment and ion sputtering includes an X-ray source including one or more field emitter arrays and a circuit configured to control the one or more field emitter arrays. The one or more field emitter arrays include a gate and an emitter. The circuit is configured to apply a voltage between the gate and the emitter.

### CROSS-REFERENCE TO RELATED APPLICATION

This application claims the benefit of, and priority to, U.S. Provisional Patent Application No. 63/396,689 filed on Aug. 10, 2022, the entire contents of which are hereby incorporated herein by reference.

### TECHNICAL FIELD

The present disclosure relates to a system design for X-ray imaging equipment including digital radiography, fluoroscopy, tomosynthesis, and computed tomography (CT).

### BACKGROUND

Field emission has been proposed as a cathode for X-ray sources, and arrays of nanostructures are used to get relevant current levels for practical applications. Field emission-based X-ray sources enable normally-off, room temperature operation with close cathode-to-cathode spacing necessary for distributed and multi-source X-ray source imaging applications such as tomosynthesis and computed tomography. Reliability has been a key challenge for field emission-based sources when compared to traditional thermionic sources, usually tungsten-based filament. Field emission cathodes have been made using a variety of solid-state materials such as silicon, molybdenum, and carbon nanotubes relative to thermionic sources and emit from their sharp tip-like surfaces meaning transport and damage of the tip leads to changes in device performance. Their physical operating mechanism makes field emitter devices more susceptible to high-voltage reliability challenges.

### SUMMARY

An aspect of the present disclosure provides a system including: an X-ray source including one or more field emitter arrays and a circuit configured to control the one or more field emitter arrays. The one or more field emitter arrays include a gate and an emitter. The circuit is configured to apply a voltage between the gate and the emitter.

In an aspect of the present disclosure, the X-ray source may further include an anode. The voltage includes a waveform having a duty cycle greater than about 5% and a pulse width shorter than a transit time of an ion between the anode and the one or more field emitter arrays.

In an aspect of the present disclosure, the X-ray source may further include an anode. The voltage is applied between the gate and emitter of each of the one or more field emitter arrays. The circuit is configured to vary the voltage to alternate which of the one or more field emitter arrays are configured to emit electrons while maintaining a duty cycle greater than 5% for each of the one or more field emitter arrays. The voltage has a pulse width shorter than a transit time of an ion between the anode and the one or more field emitter arrays.

In an aspect of the present disclosure, the X-ray source may further include an anode and a field emitter array protection. The field emitter array protection is configured to shield the field emitter array from back-bombarding ions emerging from the anode, and deflect an electron beam from impacting a position within line of sight from the anode to the field emitter array.

In another aspect of the present disclosure, the field emitter array protection may include a conductor.

In an aspect of the present disclosure, the X-ray source may further include an anode and one or more pairs of conductors configured to deflect an electron beam. The electron beam is deflected by applying an electrostatic force to the one or more pairs of conductors. The one or more pairs of conductors are of opposite voltage polarity and are configured to cause an impact of electrons on the anode out of line of sight of the field emitter array.

In an aspect of the present disclosure, the X-ray source may further include an anode, an X-ray tube, and one or more magnets located inside or outside of the X-ray tube and configured to apply a magnetic force. The one or more magnets are configured to deflect an electron beam by the magnetic force and cause an impact of electrons on the anode out of line of sight of the field emitter array.

In another aspect of the present disclosure, the one or more magnets are permanent magnets or electromagnets.

In an aspect of the present disclosure, the X-ray source may further include an anode, a plurality of electrostatic electrodes configured to apply an electrostatic force, and an electromagnet configured to apply a magnetic force. The electrostatic electrodes and the electromagnet are configured to deflect an electron beam by a combination of the electrostatic force and the magnetic force and cause an impact of the electrons on the anode out of line of sight of the field emitter array.

In an aspect of the present disclosure, the one or more field emitter arrays may be configured to achieve a desired electron focal spot size after manipulation from an electrostatic force or a magnetic force out of line of sight of the field emitter array.

In an aspect of the present disclosure, the X-ray source may further include an anode, wherein the voltage is applied between the gate and emitter of each of the one or more field emitter arrays. The circuit is configured to vary the voltage to alternate which of the one or more field emitter arrays are configured to emit electrons while maintaining a duty cycle greater than approximately 5% for each of the one or more field emitter arrays. The voltage has a pulse width longer than a transit time of an ion between the anode and one of more field emitter arrays.

In an aspect of the present disclosure, the one or more field emitter arrays may operate with more than one on at a time, providing one or more discrete focal spot sizes which are configured for emitting X-rays.

In another aspect of the present disclosure, the system may further include a transient voltage suppressor in parallel with the gate and the emitter contacts of the X-ray source.

Further details and aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a block diagram of an X-ray tube connected with its control circuitry and power supplies, in accordance with aspects of the disclosure;

FIG. 2 is a graph illustrating an exemplary waveform of the gate to emitter voltage and anode current as a function of time, in accordance with aspects of the disclosure;

FIG. 3 is a graph illustrating an exemplary waveform of the gate-to-emitter voltage and anode current measured as an output of an exemplary X-ray source containing two field emitter arrays, in accordance with aspects of the disclosure;

FIG. 4 is a side cutaway view of an X-ray tube without any beam deflection with the path of the electron beam and returning ions, in accordance with aspects of the disclosure;

FIG. 5 is a side cutaway view of an X-ray tube with beam deflection with the path of the electron beam and returning ions, in accordance with aspects of the disclosure;

FIG. 6 is a side cutaway view of an X-ray tube with electrostatic beam deflection placed before and after the field emitter array protection after the electrons leave the field emitter array, in accordance with aspects of the disclosure;

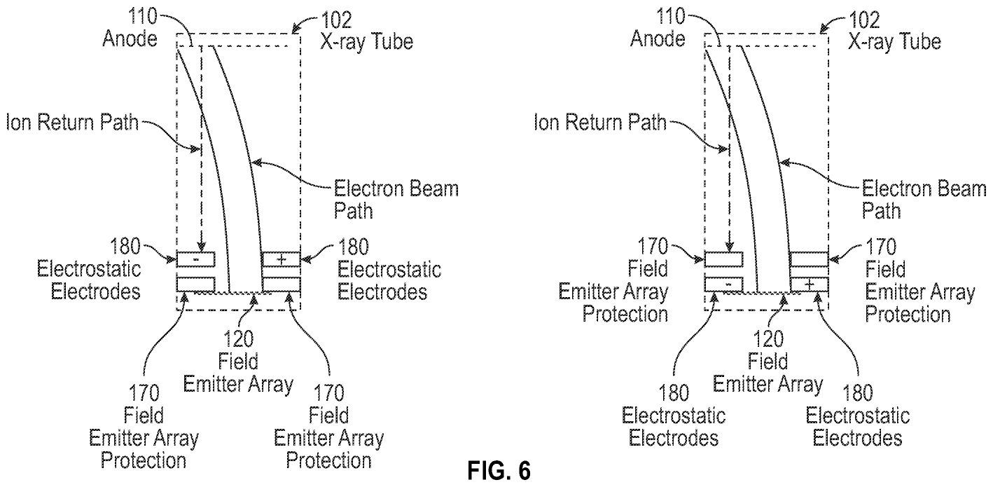

FIG. 7 is a side cutaway view of an exemplary X-ray tube with an internal and external electromagnetic to apply a magnetic field to influence the path of electrons and ions, in accordance with aspects of the disclosure;

FIG. 8 is a side cutaway view of an exemplary X-ray tube with electrostatic beam deflection using an electromagnet, in accordance with aspects of the disclosure;

FIG. 9 is a diagram of the field emitter arrays of the X-ray tube of FIG. 1, in accordance with aspects of the disclosure;

FIG. 10 is a diagram of the field emitter arrays of the X-ray tube of FIG. 9, in accordance with aspects of the disclosure; and

FIG. 11 is a diagram of a plurality of field emitter arrays from a plurality of discrete X-ray sources, in accordance with aspects of the disclosure.

### DETAILED DESCRIPTION

The present disclosure relates to a system using field emission X-ray sources which would be used in conventional 2D, tomosynthesis and computed tomography (CT). Previous field emission X-ray sources did not employ methods to handle reliability challenges related to the ionizing X-ray environment.

Vacuum arcing is a main reliability challenge for both field emission and thermionic cathodes in X-ray sources. Vacuum arcing is caused by a positive feedback loop of ion formation, causing the anode, gate, and cathode to be shorted to each other. In thermionic X-ray sources, the X-ray output is temporarily disabled until the arc event has passed, resulting in missing X-ray images during the computed tomography scan. In field emission-based X-ray sources, the arcing leads to catastrophic failure exposing the field emitting material and gate to high voltage. The field emitters often have reduced current or higher current between the gate and emitter terminals, potentially requiring replacement to meet the performance requirements. This is alleviated by degassing all components carefully, but is not enough to make field emitters reliable.

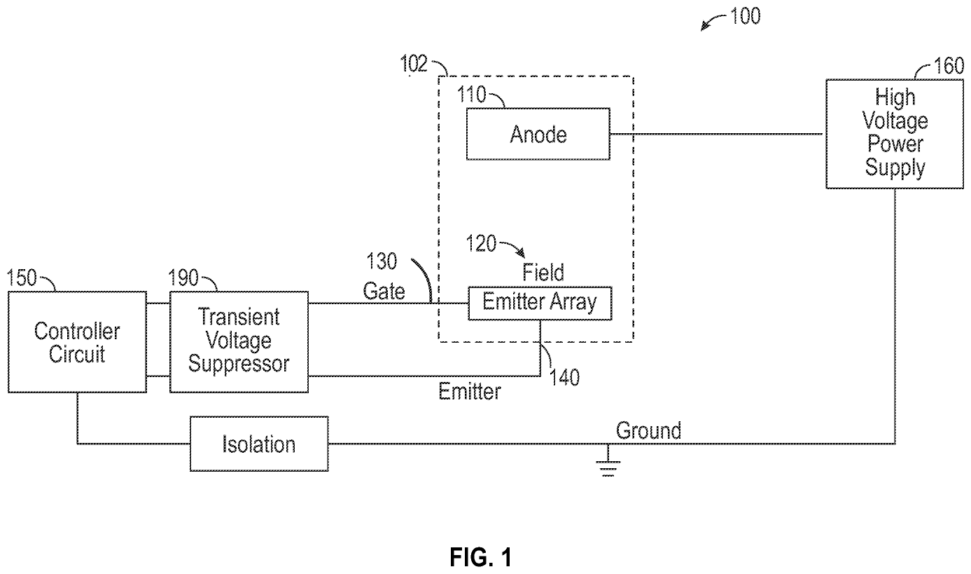

Referring to FIG. 1, a block diagram of a system 100, including an X-ray source 102 is shown. The X-ray source 102 (e.g., X-ray tube) includes one or more field emitter arrays 120, a control circuit 150 configured to control the one or more field emitter arrays 120, and a power supply 160. The one or more field emitter arrays 120 include a gate 130, an anode 110, and an emitter 140. The control circuit 150 is configured to apply a voltage between the gate 130 and emitter 140. In aspects, the X-ray source 102 may further include a transient voltage suppressor 190.

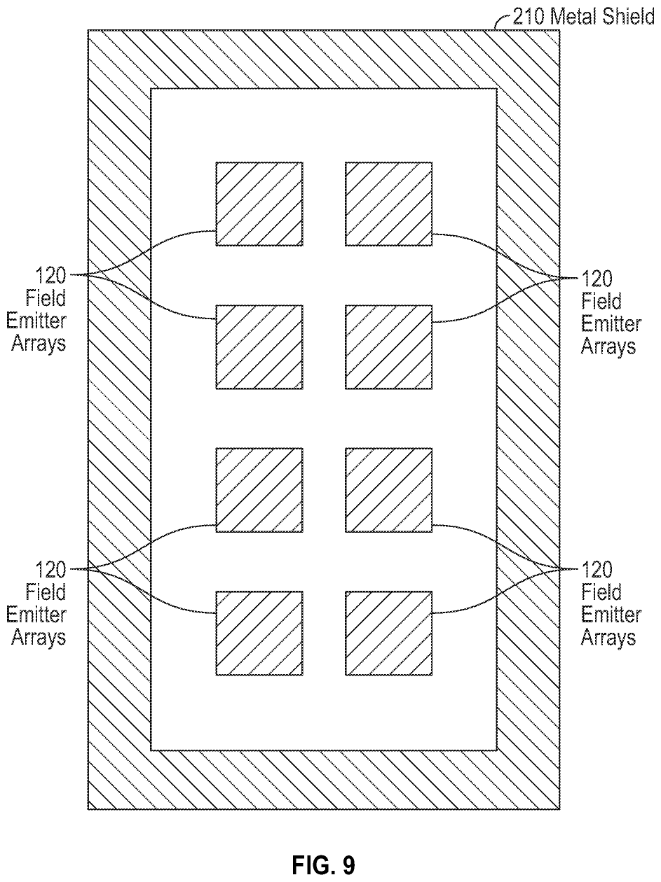

Arcs in the vacuum tube are inevitable, and proper design of the X-ray tube and circuitry are necessary to prevent the effects of arcing even if they do not directly impact the field emitter array. The transient voltage suppressor 190 may include electrostatic discharge (ESD) devices, for example, diodes, thyristors, and circuitry. The transient voltage suppressor 190 may be integrated in parallel with the gate and the emitter contacts of the cathode in order to mitigate failure through either an excessive surge in current or overvoltage on the X-ray source 102. Another method to reduce the overall impact of a vacuum arc on the silicon field emitter arrays is to provide an isolated power supply from other components and to implement structures, i.e., grounded metal “cages” in one or more dimensions, to shield the silicon field emitter arrays from the resulting electromagnetic fields which arise from the arc. In aspects, metal could be used as a Faraday cage to shield the field emitter arrays 120 from certain fields (FIG. 9).

The system 100 includes an operating design for field emitters that are designed to mitigate the potential for vacuum arcing in field emitters. Field emitters have the potential to be operated at high frequencies (less than about 10 ns), with higher than required current levels, and with low voltages (less than about 100 V). These capabilities enable a design for operating field emission X-ray sources by turning on and off the X-ray source 102 controlled by a controller 150 and/or a circuitry designed to operate with a high-duty cycle (greater than about 5%) with a pulse width shorter than the time required for ions to build up causing a vacuum arc. A vacuum arc can occur when ions from the anode 110 or field emitter array 120 cascade and reach the opposite terminal causing a catastrophic failure of the field emitter array 120. The controller 150 may include a processor and memory, or a circuit.

In aspects, the controller 150 may apply the voltage between the gate and emitter of each of the one or more field emitter arrays. The controller 150 may be further configured to vary the voltage to alternate which of the one or more field emitter arrays emit electrons while maintaining a duty cycle greater than about 5% for each of the one or more field emitter arrays. The voltage has a pulse width longer than the transit time of an ion between the anode and one or more field emitter arrays. This provides benefit of giving an emitter “rest” will reduce the impact of ion back bombardment on the device.

In aspects, the one or more field emitter arrays operate with more than one on at a time, providing one or more discrete focal spot sizes from which X-rays can emit.

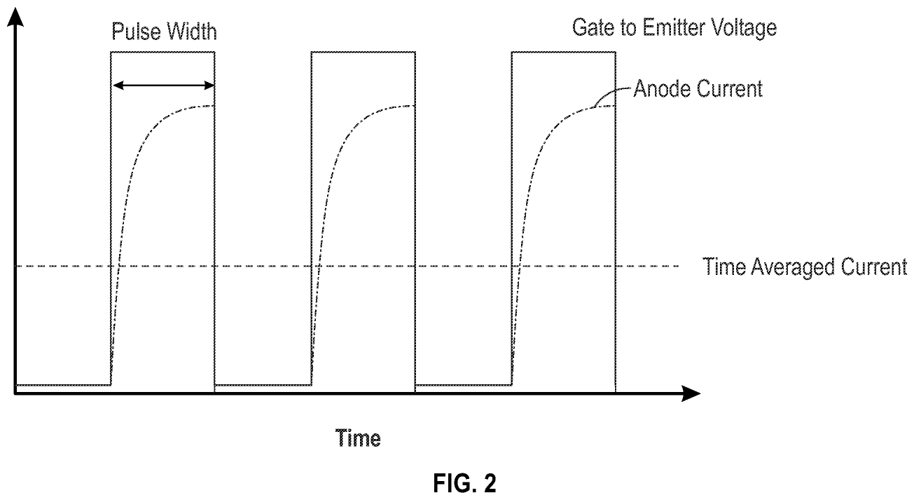

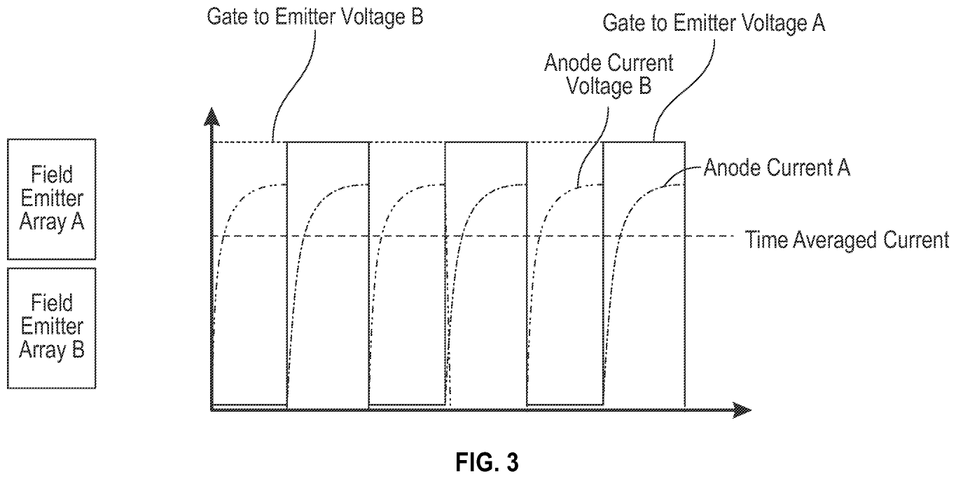

Referring to FIG. 2, a diagram illustrating the pulsed gate 130 voltage relative to the emitter 140 voltage along with the expected anode 110 current is shown. The voltage is duty cycled at greater than about 5% to get the desired continuous on-current required for the application. However, the X-ray source 102 is turned on and off quickly enough to prevent any continuous stream of ions from forming, preventing a vacuum arc. This can also be applied to more than one field emitter array 120 to maintain the continuous anode 110 current at lower current drives as shown in FIG. 3. In addition to reducing the potential for a vacuum arc, the moving of the focal spot may be used for anti-aliasing.

Additional reliability mechanisms for field emitter arrays are ion back bombardment and sputtering, which originate from the ionization of gas molecules within the high electric field between the anode and cathode. The ions formed within the high electric field are accelerated into the field emitter array causing bulk crystal damage and sputtering of material from the field emitter array. Ion back bombardment is noticeable in conventional thermionic X-ray sources but is more detrimental to the field emission sources due to crystalline surface structures. The present disclosure includes multiple structures which can reduce both ion back bombardment and sputtering of the cathode.

The disclosed approach uses a high-aspect ratio conductor or the field emitter array protection 170 to shield the cathode from the line of sight from the electron focal spot on the anode 110 using electrostatic or magnetic forces.

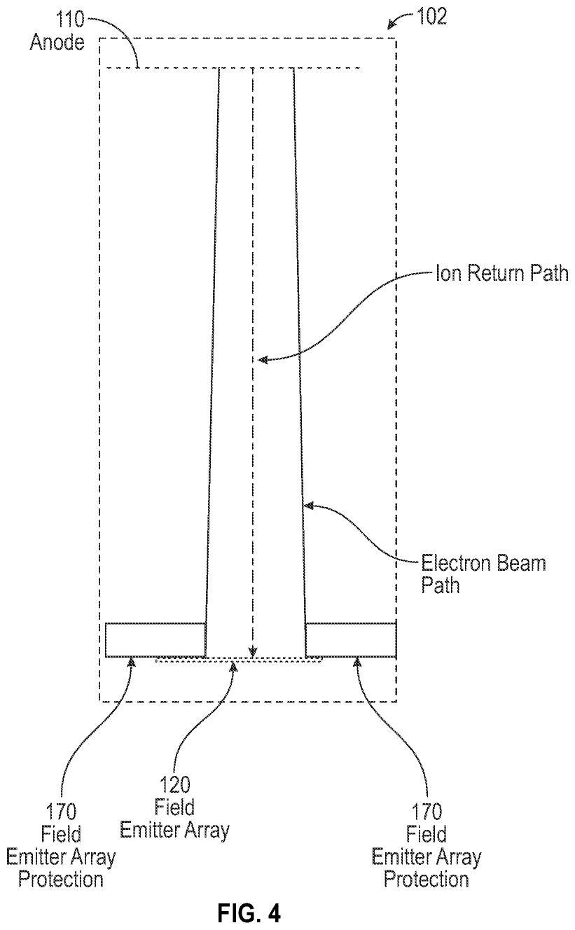

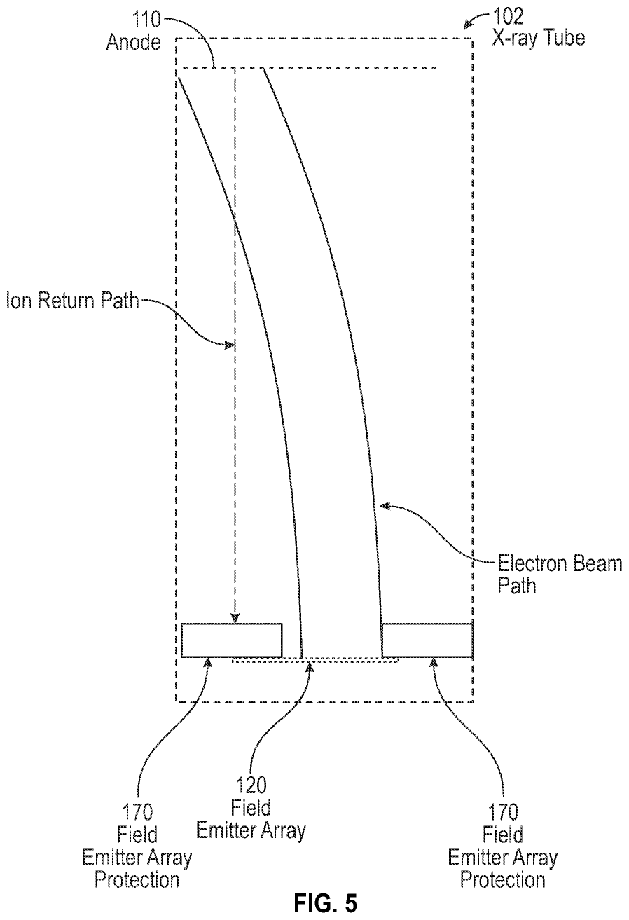

FIG. 4 shows a field emission X-ray source arrangement where the cathode is in direct line of sight of the ions. The back-bombarded and sputtered ions strike the cathode and degrade the field emission material over time. FIG. 5 shows an exemplary figure of an X-ray source 102 configuration illustrating the direction of the applied force from the electrostatic or magnetic field and the trajectory of the electron beam. In this configuration, most of the electron beam's path is cut off from the line of sight relative to the field emitter arrays 120 resulting in a significant decrease in the net ion flux and limiting the energy of the ions which impinge on the field emitter array greatly improving the overall reliability of the structure.

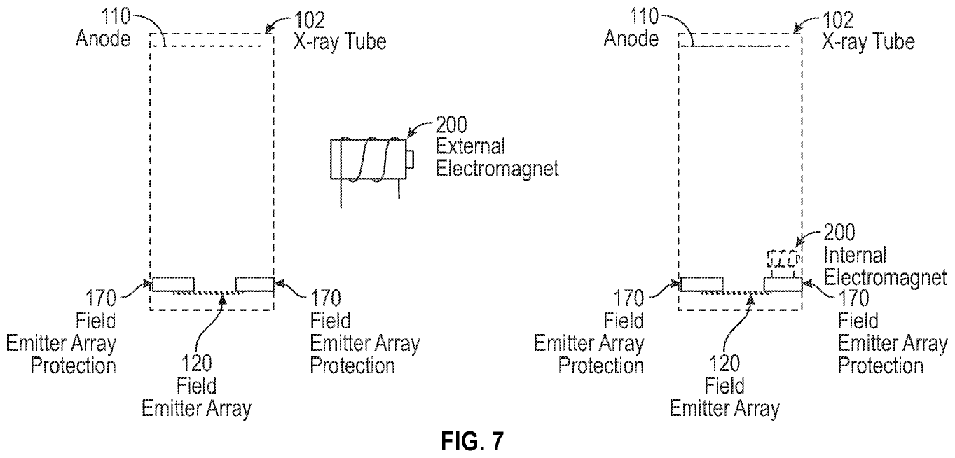

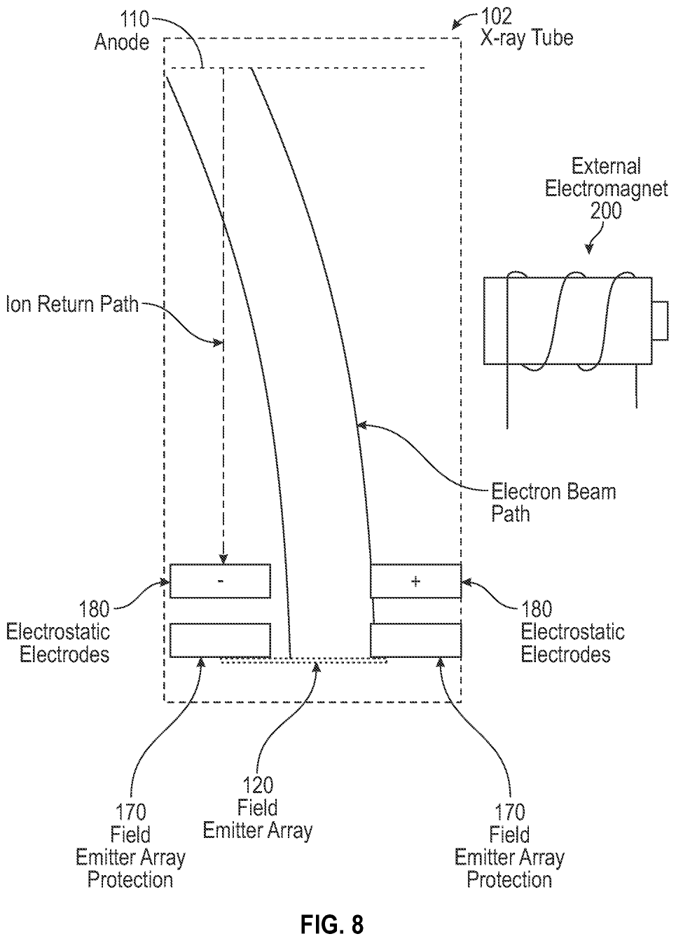

A magnetic field can be applied in order to achieve similar results by integrating permanent or electromagnets 200 either inside or outside of the X-ray source 102 as seen in FIG. 7. The magnetic field causes the electron beam to bend relative to the anode and is situated in a way which causes the electrons to impact its desired location. The magnetic field can be integrated with an electrostatic field as well to obtain a desired beam path (FIG. 8). For example, the X-ray source 102 may include electrostatic electrodes 180.

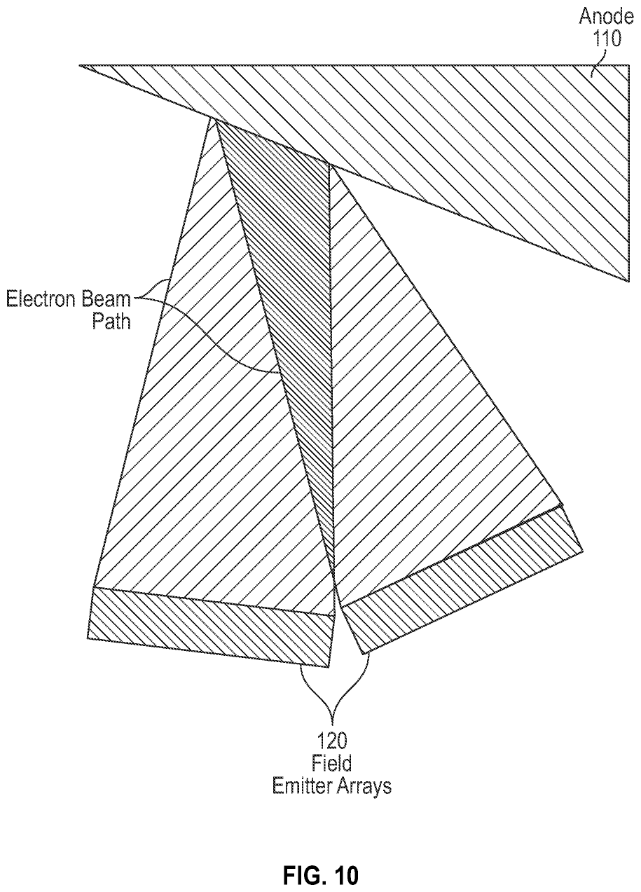

Referring to FIG. 10, there are multiple possible configurations for implementing electrostatic and magnetic fields to manipulate the beam to follow a particular direction. Electrostatic manipulation requires applying a potential on either side of the electron beam, for example, by using electrostatic electrodes 180 (FIG. 8). Off-center deflection is achieved by applying a positive and negative potential on opposite sides of the electron beam and more than one layer of electrostatic potentials can be applied in order to manipulate the beam in multiple directions. These electrostatic potentials and gates can be integrated before or after the ion collector to prevent ions from impacting the cathode and may be integrated within the packaging of the X-ray source 102 (e.g., X-ray tube).

Because the different forces will deflect the electron beam, it is possible that the focal spot size will also change in shape and size. To account for the change in shape and size, the shape of the field emitter array may be modified to compensate for the expected size change of the spot on the anode. This may be accomplished by one of two methods, with the field emitter's lithographically patterned size and shape being altered to the desired shape or by turning on multiple tiles to achieve a given cathode emission shape.

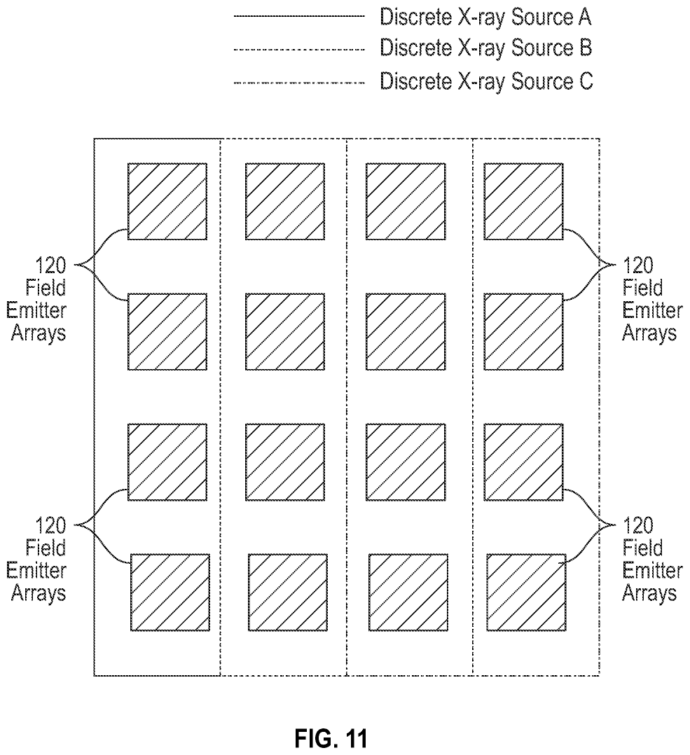

Referring to FIG. 11, one or more redundant and similar field emitter arrays 120 (e.g., silicon field emitter arrays) can be integrated in the event of that one or more field emitter arrays 120 is destroyed which would result in the loss of functionality of a given array. This may be part of the existing tile of arrays or another explicit set of field emitter arrays 120 but would not be operational at the same time. In aspects, this section would only be active in the event of destruction of the primary cathode to continue with imaging.

The aspects disclosed herein are examples of the claimed subject matter, which may be embodied in various forms. For instance, although certain aspects herein are separately described, it should be appreciated that each of the aspects herein may be combined with one or more of the other aspects described herein. Specific structural and functional details disclosed herein are not to be interpreted as limiting, but as a basis for the claims and as a representative basis for teaching one skilled in the art to variously employ the disclosure in virtually any appropriately detailed structure. Like reference numerals may refer to similar or identical elements throughout the description of the figures.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example Aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system comprising:
an X-ray source including:
one or more field emitter arrays, including:
a gate; and
an emitter; and
a circuit configured to control the one or more field emitter arrays and apply a voltage between the gate and the emitter.

2. The system of claim 1, wherein the X-ray source further includes an anode, and wherein the voltage comprises a waveform having a duty cycle greater than about 5% and a pulse width shorter than a transit time of an ion between the anode and the one or more field emitter arrays.

3. The system of claim 1, wherein the X-ray source further includes an anode,
wherein the voltage is applied between the gate and emitter of each of the one or more field emitter arrays,
wherein the circuit is configured to vary the voltage to alternate which of the one or more field emitter arrays are configured to emit electrons while maintaining a duty cycle greater than 5% for each of the one or more field emitter arrays, and
wherein the voltage has a pulse width shorter than a transit time of an ion between the anode and the one or more field emitter arrays.

4. The system of claim 1, wherein the X-ray source further includes:
an anode; and
a field emitter array protection configured to:
shield the field emitter array from back-bombarding ions emerging from the anode; and
deflect an electron beam from impacting a position within line of sight from the anode to the field emitter array.

5. The system of claim 4, wherein the field emitter array protection is a conductor.

6. The system of claim 1, wherein the X-ray source further includes:
an anode; and
one or more pairs of conductors configured to deflect an electron beam, wherein the electron beam is deflected by applying an electrostatic force to the one or more pairs of conductors, and
wherein the one or more pairs of conductors are of opposite voltage polarity and are configured to cause an impact of electrons on the anode out of line of sight of the field emitter array.

7. The system of claim 1, wherein the X-ray source further includes:
an anode;
an X-ray tube; and
one or more magnets located inside or outside of the X-ray tube and configured to apply a magnetic force, wherein the one or more magnets are configured to deflect an electron beam by the magnetic force and cause an impact of electrons on the anode out of line of sight of the field emitter array.

8. The system of claim 7, wherein the one or more magnets are permanent magnets or electromagnets.

9. The system of claim 1, wherein the X-ray source further includes:
an anode;
a plurality of electrostatic electrodes configured to apply an electrostatic force; and
an electromagnet configured to apply a magnetic force,
wherein the electrostatic electrodes and the electromagnet are configured to deflect an electron beam by a combination of the electrostatic force and the magnetic force and cause an impact of the electrons on the anode out of line of sight of the field emitter array.

10. The system of claim 1, wherein the one or more field emitter arrays are configured to achieve a desired electron focal spot size after manipulation from an electrostatic force or a magnetic force out of line of sight of the field emitter array.

11. The system of claim 1, wherein the X-ray source further includes an anode, wherein the voltage is applied between the gate and emitter of each of the one or more field emitter arrays, and
wherein the circuit is configured to vary the voltage to alternate which of the one or more field emitter arrays are configured to emit electrons while maintaining a duty cycle greater than approximately 5% for each of the one or more field emitter arrays, and
wherein the voltage has a pulse width longer than a transit time of an ion between the anode and one of more field emitter arrays.

12. The system of claim 1, wherein the one or more field emitter arrays operate with more than one on at a time providing one or more discrete focal spot sizes which are configured for emitting X-rays.

13. The system of claim 1, further comprising a transient voltage suppressor in parallel with the gate and the emitter contacts of the X-ray source.
